(19) United States
(12) Patent Application Publication
(10) Pub. No.: US 2008/0080940 A1
(43) Pub. Date: Apr. 3, 2008

(54) Drilling tool, a method for drilling a hole and a use of a drilling tool

(75) Inventors: Johnny Peder Sorensen, Herning (DK); Flemming Bunde, Silkeborg (DK)

Correspondence Address: FOLEY AND LARDNER LLP;SUITE 500, 3000 K STREET NW, WASHINGTON, DC, 20007, US

(73) Assignee: UNIMERCO A/S

(21) Appl. No.: 11/515,424

(22) Filed: Sep. 5, 2006

(51) Int. Cl. B23B 51/00

(52) U.S. Cl. 408/223

(57) ABSTRACT

A drilling tool of the invention can drill a hole in a work-piece that has a passage, already provided, the diameter of which is to be increased by drilling. In particular, the passage has a discontinuity along the hole, where the diameter of the hole is to be increased along a shorter or longer extension of the hole. To accommodate this task, the drilling tool has a drill head that is provided with (i) at least one first cutting element, extending substantially perpendicular to the rotational axis, and (ii) at least one second cutting element, extending obliquely to the rotational axis. The first cutting element has a first radial extension (r) from the rotational axis, and at least one cutting element has a second radial extension (R) from the rotational axis, such that r is smaller than R.

### FIELD OF THE INVENTION

The invention relates to a drilling tool with a shaft and a drill head, said drilling tool during drilling intended for rotation around a rotational axis, and on which drill head a tip with at least two different cutting elements are provided, and said drill head being manufactured from a base body of a base material with a circumferential surface.

The invention also relates to a method for drilling a hole in a work-piece at least partly made of a material having a brittle texture, and where a passage is provided in the in the material having a brittle texture, said passage having a circular-cylindrical extension with a preliminary diameter, said passage having at least one discontinuity, said discontinuity increasing the preliminary diameter of the passage, and where the diameter of the passage is intended for being increased by drilling with a drilling tool along the passage.

Furthermore, the invention relates to use of a drilling tool with a shaft and a drill head, said drilling tool during drilling intended for rotation around a rotational axis, and on which drill head a tip with at least two different cutting elements are provided, and said drill head being manufactured from a base body of a base material with a circumferential surface, said use applied for drilling a hole in a work-piece at least partly made of a material having a brittle texture, and where a passage is provided in the in the material having a brittle texture, said passage having a circular-cylindrical extension with a preliminary diameter, said passage having at least one discontinuity, said discontinuity increasing the preliminary diameter of the passage, and where the diameter of the passage is intended for being increased by drilling with a drilling tool along the passage.

### BACKGROUND OF THE INVENTION

Prior art drilling tools, for drilling passages of the kind mentioned in the paragraph ‘Field of the invention’, result in poor quality due to the formation of ring-like debris. Especially for work-pieces such as a valve-body, where a sliding valve is intended for fitting into the passage, ring-like debris has to be removed from the passage before the valve can be inserted into the passage. It is time- and cost-consuming having to remove, often manually, any debris from the passage.

JP 2000-84721 discloses a drilling tool having a specially designed tip. The tip is designed to provide a sequential drilling of a hole, where the drill is the primary drilling tool, i.e. where the drill is the one to drill the first hole to be drilled in the work-piece. Both the first section of the tip and having a smaller diameter as well as the second section of the tip and having a larger diameter is pointed in order to properly abutting the work-piece to be drilled for the first time. An excessively pointed tip is however prone to misalignment when introduced into an already drilled hole to be further machined. The cutting edges of the excessively pointed tip may not abut the hole evenly along the circumference of the hole, i.e. the one cutting edge may be abutting the circumference of the hole before the other cutting edge is abutting the circumference of the hole. Thus, the one cutting edge of the excessively pointed tip will be determining the further progress of the drill through the hole.

### SUMMARY OF THE INVENTION

It may be seen as an object of the present invention to provide a drilling tool being capable of drilling holes in work-pieces having an already provided passage with a certain diameter, and which diameter is to be increased by drilling, however, where said hole has a discontinuity along the hole, where the certain diameter of the hole is increased along a shorter or longer extension of the hole.

Such work-pieces, especially when made of a cast material such as cast iron having a brittle texture, are very difficult to work due to several different problems which occur during drilling. Firstly, proper alignment of a central axis of the finished hole is difficult to obtain due to inaccuracy in the progress of the tip of the drilling tool along the still not machined passage. Secondly, different types of debris from drilling cast material having a brittle texture may occur when the drill passes from the preliminary diameter to the increasing diameter of the passage. Thirdly proper alignment of a central axis of the finished hole is furthermore difficult obtaining due to inaccuracy in the progress of the circumferential surfaces of the drilling tool along the already finished hole of the passage.

It may also be seen as an object to provide a method for increasing the diameter of such passages as mentioned above, by drilling. An object may also be to provide a usage of a drilling tool for increasing the diameter of such passages as mentioned above.

The object of providing a drilling tool is obtained by a drilling tool having a drill head, said drill head being provided with at least one first cutting element extending substantially perpendicular to the rotational axis, and at least one second cutting element extending obliquely to the rotational axis, and where said at least one first cutting element has a first radial extension (r) from the rotational axis, where said at least one cutting element has a second radial extension (R) from the rotational axis, where the first radial extension (r) is smaller than the second radial extension (R).

A drilling tool being provided with said features exhibits a very high accuracy when drilling holes in a work-piece as mentioned earlier. The specially designed tip ensures proper alignment of the tip of the drilling tool when progressing through the still not machined passage. If an ordinary drill tip is used instead of a drill tip according to the invention, the tip of the drill will have a tendency to progress slightly off-set when passing from the increased diameter of the passage to the preliminary diameter of the passage, i.e. when passing the discontinuities of the passage.

The more conventional part of the drilling tip, i.e. the second cutting elements, ensures a drilling of the passage to a partly or fully finished diameter, with the least amount of torque and axial tension needed.

In a preferred embodiment, the at least one first cutting element forms an angular extension of between 75 degrees and 90 degrees with the rotational axis of the drilling tool, preferably between 80 degrees and 90 degrees with the rotational axis (A), even preferred between 85 degrees and 90 degrees with the rotational axis (A). A first cutting element being provided with such high angular extension with the rotational axis ensures that any possible debris from the drilling is minimized when progressing through the still not finished passage. Especially the effect of possibly a ring being formed is avoided when the drill progresses from the preliminary diameter to the increased diameter, i.e. when progressing into the discontinuity. Ring forming is especially pronounced when drilling cast iron.

In still a preferred embodiment, the at least second cutting element forms an angular extension of between 1 degree and 60 degrees with the rotational axis of the drilling tool. A second cutting edge being provided with a lower angular extension with the rotational axis than the first cutting element, ensures that the finishing of the passage, at least by the drilling tool of the invention, i.e. drilling the passage to the fully or partly finished diameter of the drilling tool of the invention, is performed as a conventional drilling process with the advantages of a conventional drilling process, i.e. reduced torque requirement of the drilling tool and well defined machining with low tolerances for finishing the passage to the desired diameter.

In a possible embodiment, the at least one first cutting element constitutes a cutting edge with a geometry similar to a milling edge provided at a tip of the drilling head, said cutting edge extending to the first radial extension from the rotational axis, and where the cutting edge preferably has a substantially linear extension, and where the cutting edge even preferred has an extension in at least two different directions as seen from the rotational axis and said extension in the at least two different directions being equally distributed perpendicular to a plane extending along the rotational axis and on each side of the plane. Alternatively, the cutting edge has an extension in at least three different directions around the rotational axis, and where said extension in the at least three different directions is distributed, either by an an even pitch or by an uneven pitch, around the rotational axis.

A first cutting element having a cutting edge functioning more as a milling edge than a drilling edge further increase the advantages of the present invention, namely the advantage of any possible debris from the drilling being minimized when progressing the cutting edge at the tip of the drilling tool through the still not finished passage. Especially the effect of possibly a ring being formed is further avoided when the cutting edge progresses from the preliminary diameter to the increased diameter, i.e. when the cutting edge is progressing into the discontinuity. Ring forming is especially pronounced when drilling cast iron.

In a possible embodiment, the at least one second cutting element constitutes a cutting edge being part of a twisted, fluted surface and being provided at a tip of the drilling head, said cutting edge being part of the twisted, fluted surface extending from the first radial extension to the second radial extension as seen from the rotational axis, and where the cutting edge has a substantially cone-frustum shaped extension, and where the cutting edge has an extension in at least two different directions from the rotational axis and said extension in the at least two different directions being equally distributed perpendicular to a plane extending along the rotational axis and on each side of the plane. Alternatively, the at least one second cutting edge (5) has an extension in three different directions around the rotational axis (A), and said extension in the three different directions being distributed, by an even pitch or by an uneven pitch, around the rotational axis.

A second cutting element constituting part of a twisted cutting element further increase the advantages of the present invention, namely the advantage of any debris such as chips from the drilling being transported out of the passage by the twisted cutting element when progressing the cutting edge at the tip of the drilling tool through the passage when being finished. Thus, the advantages of the conventional drilling process, i.e. reduced torque requirement of the drilling tool and well defined machining with low tolerances for finishing the passage to the desired diameter.

Possibly the radial extension of the first cutting element is at the most 20% larger than the preliminary radius of the passage, even possibly the radial extension of the first cutting element is at the most 15% larger than the preliminary radius of the passage, even still possibly the radial extension of the first cutting element is at the most 10% larger than the preliminary radius of the passage, and further even still possibly the radial extension of the first cutting element is at the most 5% larger than the preliminary radius of the passage.

Possibly the radial extension of the second cutting element is more than 5% larger than the radius of the passage after having been machined by the first cutting element, even possibly the radial extension of the second cutting element is more than 10% larger than the preliminary radius of the passage, even still possibly the radial extension of the second cutting element is more than 15% larger than the preliminary radius of the passage, and further even still possibly the radial extension of the second cutting element is more than 10% larger than the preliminary radius of the passage.

In summary, the drilling tool according to the invention has the technical effect of no ring-like debris being formed. Furthermore, the machining speed, i.e. the time spent for drilling the passage with the drilling tool according to the invention, is faster than when drilling with prior art drilling tools. Up to at least 15% time is saved, possibly up to 30% or even more time is saved. This is due to the fact of a better alignment and accordingly a possibility of faster axial progress of the drilling tool along the passage. If the number of twisted cutting edges is increased from two to three or more, the time spent is very low due to a very good alignment of the drilling tool in the passage. Also, if the number of lands along the twisted cutting edges is two, rather than one, the time spent is also very low, also due to a very good alignment of the drilling tool in the passage.

### BRIEF DESCRIPTION OF THE DRAWINGS

In the following, the invention will be described with reference to the drawings, where

FIG. 1 is a drawing showing an embodiment of a drilling tool according to the invention together with a work-piece to be machined, before insertion of the drilling tool into a passage of the work-piece,

FIG. 2 is a drawing showing the embodiment of the drilling tool together with a work-piece being machined, after and during insertion of the drilling tool into a passage of the work-piece,

FIG. 3 is a drawing showing the embodiment of the drilling tool together with the work-piece having been partly machined, having the drilling tool retracted from the passage of the work-piece, and

FIG. 4 is a drawing showing the tip of the embodiment of the drilling tool according to the invention.

### DETAILED DESCRIPTION OF THE INVENTION

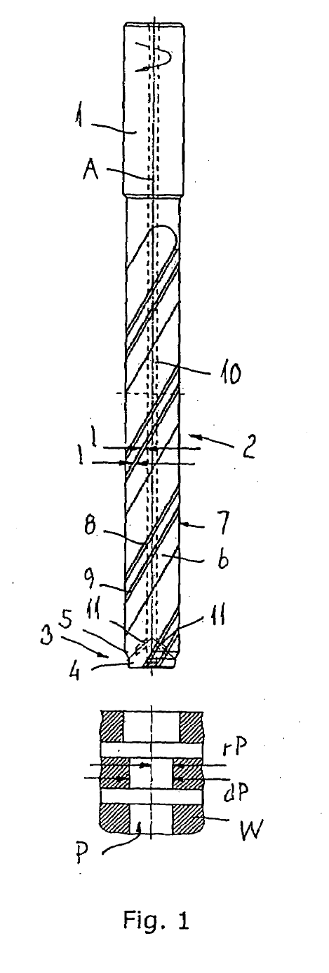

FIG. 1 is a drawing of an embodiment of a drilling tool having a shaft 1, a drilling head 2 and a tip 3 constituting part of the drilling head 2. The tip is provided with a first cutting element 4 and a second cutting element 5. The first cutting element 4 has the shape of a milling edge, and the second cutting element 5 has the shape of a section of a pointed part of a surface having twisted flutes 6, i.e. the second cutting element has the shape of part of a conventional drilling tool. The remaining part of the twisted cutting edge 6 extends along a circumferential surface 7 of the drilling tool.

The twisted fluted surface 6 is provided with a first land 8 and a second land 9. Possibly, the twisted fluted surface 6 could be provided with three or even more lands. In the embodiment shown, the first land 8 is a leading land and the second land 9 is a trailing land with respect to the intended rotational direction around a rotational axis A of the drilling tool. The first leading land 8 and the second trailing land 9 are both intended for abutting the passage having been finalized by the second cutting element 5. The first leading land 8 and the second trailing land 9 have an extension I, seen in a direction perpendicular to the rotational axis A of the drilling tool, of between 1% and 10% of the overall diameter of the drilling tool.

The drilling tool shown in the figures also have an internal channel 10, shown by a dotted line, and extending longitudinally along the rotational axis A of the drilling tool. At the tip of the drilling tool the channel 10 is divided into two branch channels 11 with orifices (not shown) in the flutes. The channels 10, 11 are intended for supplying cooling and/or lubricating liquid to the tip of the drilling tool.

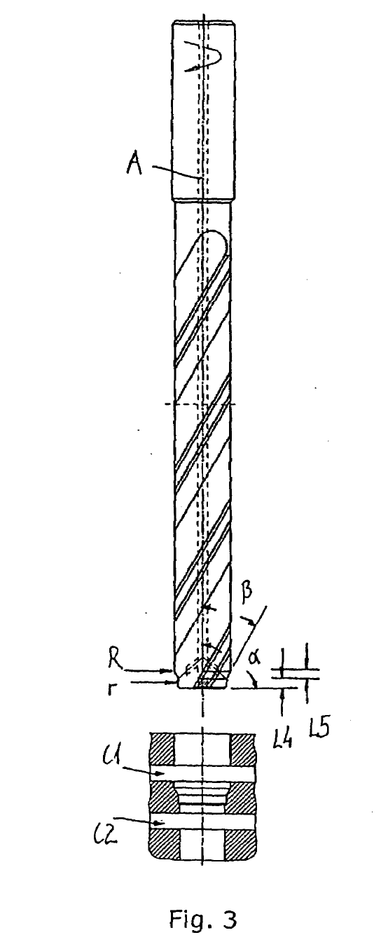

The tip 2 of the drilling tool is, as mentioned, divided into a first cutting element 4 and a second cutting element 5. The first cutting element 4 has a radial extension r (see FIG. 3) from the rotational axis A of the drilling tool. The second cutting element 5 has a radial extension R (see FIG. 3) from the rotational axis A of the drilling tool. The first cutting element 4 extends along an angle α (see FIG. 3) to the rotational axis A. In the embodiment shown, the angle α is 90 degrees to the rotational axis A, i.e. the first cutting element 4 extends perpendicular to the rotational axis A.

The second cutting element 5 extends along an angle β (see FIG. 3) to the rotational axis A. In the embodiment shown, the angle β is 60 degrees to the rotational axis A, i.e. the second cutting element extends obliquely to the rotational axis. The angle α may have a value between 75 degrees and 90 degrees, preferably a value between 80 degrees and 90 degrees, even preferred a value between 85 degrees and 90 degrees. The angle β may have a value between 1 degrees and 60 degrees, preferably a value between 45 degrees and 60 degrees.

In the embodiment shown, the first cutting element has a longitudinal extension L4 parallel with the rotational axis A of the drilling tool, and the second cutting element 5 has a longitudinal extension L5 parallel with the rotational axis A. Generally, the longitudinal extension L4 of the first cutting element is preferably between 1 mm and 5 mm, and the longitudinal extension L5 of the second element is calculated based on the angle β, the overall diameter of the drill and on the difference between the radius R of the second cutting element and the radius r of the first cutting element.

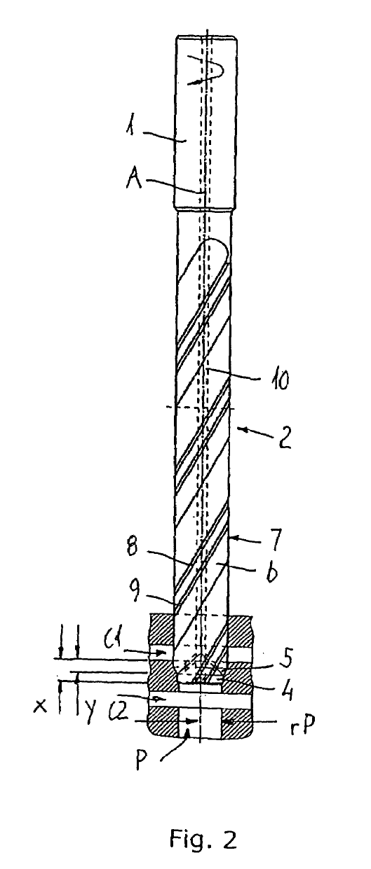

A passage P of a work-piece W to be machined (see FIG. 1) or being machined (see FIG. 2) or having been at least partly machined (see FIG. 3) has an internal preliminary diameter dP, and thus an internal preliminary radius rP. The radial extension r of the first cutting element 4 is larger than the preliminary radius rP of the passage P. However, the radial extension r of the first cutting element 4 is not much larger than the preliminary radius rP of the passage P. Preferably the radial extension r of the first cutting element 4 is at the most 25% larger than the preliminary radius rP of the passage P. In the embodiment shown in the sketch of FIG. 1, the preliminary radius rP of the passage is approximately 7 mm and the radial extension r of the first cutting element 4 is approximately 7.5 mm.

With respect to the internal preliminary radius rP of the passage P of the work-piece W, the radial extension R of the second cutting element Is also larger than the preliminary radius rP of the passage P. Indeed, the radial extension R of the second cutting element 5 is somewhat larger than the preliminary radius of the passage. Preferably the radial extension R of the second cutting element 5 is more than 5% larger than the preliminary radius rP of the passage P. In the embodiment shown in the sketch of FIG. 1, the preliminary radius rP of the passage is approximately 7 mm and the radial extension R of the second cutting element is approximately 9 mm.

In the embodiment shown of the work-piece to be machined (see FIG. 1), being machined (see FIG. 2) or having been partly machined (see FIG. 3), a pre-casting or pre-drilling has been performed of at least an initial part (see FIG. 1) of the passage P. In FIG. 2, the pre-casting or pre-drilling is not possible observing because of the drilling tool already finishing the initial part of the passage. The initial part of the passage has been pre-cast or pre-drilled to a radius being larger then the radial extension r of the first cutting element 4, but a radius being smaller than the radial extension R of the second cutting element 5. Alternatively, the initial part of the passage may be pre-cast or pre-drilled to a radius being larger then the radial extension r of the first cutting element 4, and a radius also being larger than the radial extension R of the second cutting element 5

Therefore, when the drilling tool is progressed through the initial part of the passage P, the first cutting element 4 is not performing any cutting of the Initial part of the passage. However, the second cutting element 5 will perform cutting of the initial part of the passage P, when the second cutting element 5 progresses through the initial part of the passage P. Thus, the second cutting element 5 will finish the machining of the initial part of the passage P, at least finish the machining in respect of the machining performed by the drilling tool of the invention. Possibly, both the initial part and the remaining part of the passage P may be further machined, perhaps by a reamer, in order of increasing the accuracy, and possibly also in order of decreasing the roughness, of the inner surface of the passage P.

FIG. 2 is a sketch showing the drilling tool having progressed partly through the passage P of the work-piece W to be machined. FIG. 3 is a sketch showing the drilling tool after having been retracted from the passage P, subsequent to having progressed partly through the passage P of the work-piece W.

In FIG. 2, the first cutting element 4 has progressed through the initial part of the passage P without machining the initial part of the passage P, because of the initial part of the passage having a radius being larger than the radial extension r of the first cutting element 4. The first cutting element 4 has progressed further through a first discontinuity C1 of the passage. Because the first discontinuity C1 has an increased diameter compared to the radial extension r of the first cutting element 4, the first cutting element 4 is not performing any machining of the discontinuity C1. The first discontinuity C1 also has an increased diameter compared to a subsequent and remaining part of the passage P. The remaining part of the passage P is the part still neither having been machined initially by the first cutting element 4, nor having been machined subsequently by the second cutting element 5

The first cutting element 4, as shown in FIG. 2, has progressed as far as having entered the initial part of the passage, having passed the first discontinuity C2 and having passed a distance x of the remaining part of the passage. The remaining part of the passage has a radius rP being smaller than the radial extension r of the first cutting element 4. Thus, the remaining part of the passage will be machined by the first cutting element 4. The machining performed by the first cutting element 4 Is however minor compared to a subsequent machining of the remaining part of the passage by the second cutting element 5. The radial extension r of the first cutting element 4 is preferably at the most 20% larger than the radius rP of the still non-machined remaining part of the passage P.

The second cutting element 5, as shown in FIG. 2, has progressed as far as having entered the initial part of the passage, having passed the discontinuity D1 and also having passed a distance y of the remaining part of the passage P. The remaining part of the passage P has a radius rP being smaller also than the radial extension R of the second cutting element 5. Thus, the remaining part of the passage will be further machined by the second cutting element 5. The machining performed by the second cutting element 5 is major compared to the initial machining by the first cutting element 5, the machining of which is only minor, of the remaining part of the passage.

The radial extension of the second cutting element is preferably more than 10% larger than the radius rP of the remaining part of the passage P. Accordingly, the major part, i.e. a major part of the diameter dP, of the machining by the drilling tool of the remaining part of the passage will be performed by the second cutting element, and only a minor part of the remaining passage p will be machined by the first cutting element 4.

When the first cutting element 4 is progressed further through the remaining part of the passage, and when the first cutting element 4 enters a second discontinuity C2, the remaining part of the passage will be machined by the first cutting element 4 without any ring-like debris being formed, when the first cutting element passes from the passage to the second discontinuity C2.

During prior art drilling of passages as the one showed, the drilling of the remaining part of the passage will result in ring-like debris being formed, when prior art drilling tools passes from the passage P to the second discontinuity C2 and to any similar subsequent discontinuity. Ring-like debris is a ring shaped by the material of the very last extension of the remaining passage, just in the transition between the remaining passage and the discontinuity. Ring-like debris is being formed during prior art drilling because of the brittle texture of the material of the work-price.

During prior art drilling, ring-like debris enters the discontinuity and has to be removed from the discontinuity, before the work-piece can be taken into practical usage, as example as a valve-body with valves intended for sliding along the entire of the machined and finished passage. Valves are not capable of sliding in the finished passage, or valves when sliding in the passage will at least destroy the inner surface of the passage, if ring-like debris is present in any discontinuity along the passage.

When drilling passages as the one shown, i.e. with discontinuities with an increased diameter, and when utilising a drilling tool according to the present invention, debris-free machining of the passage will be present along any entire extension of the passage and past any number of discontinuities having an increased diameter In comparison with the preliminary diameter dP of the passage.

Therefore, the drilling tool of the present invention is capable of machining any longitudinal extension of the passage and is capable of machining passages having any number of discontinuities having an increased diameter in comparison with the preliminary diameter of the passage. The first cutting element 4 ensures such machining of the passage free of ring-like debris together with also ensuring a proper alignment of the drilling tool when progressing through the passage P.

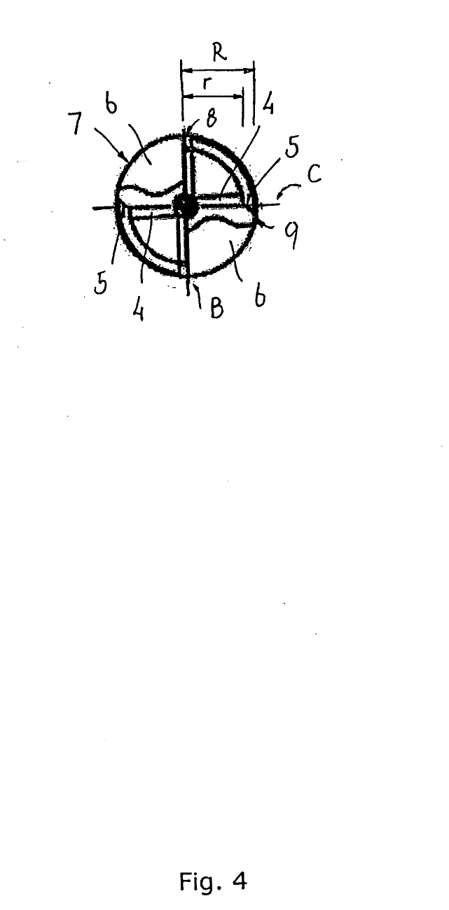

FIG. 4 is a sketch showing the tip of the drilling tool, viewed along the rotational axis A (see FIG. 1) of the drilling tool. The first cutting element 4 has a radius r from the rotational axis A of the drilling tool. In the preferred embodiment shown, the first cutting element 4 is extending in two different directions as seen from the rotational axis A. The extension in the two different directions is equally distributed perpendicular to, and on each side of, a plane B extending vertically in the drawing and extending along the rotational axis. Furthermore, the extension in the two different directions is equally distributed parallel to, and on each side of, a plane C also extending vertically in the drawing and extending along the rotational axis.

In alternative embodiments, the first cutting element 4 may have an extension in three or more different directions by multiplying the number of cutting edges around the rotational axis of the drilling tool. In still a possible, however not preferred, embodiment, the first cutting element may have an extension in only one direction from the rotational axis of the drilling tool. Such an embodiment, although possible, will however have a limited technical effect with respect to alignment of the drilling tool in the passage.

The second cutting element 5 has a radius R from the rotational axis A (see FIG. 1) of the drilling tool. In the preferred embodiment shown, the second cutting element 5 is also extending in two different directions as seen from the rotational axis. The extension in the two different directions is equally distributed perpendicular to, and on each side of, the plane B extending vertically in the drawing and extending along the rotational axis. Furthermore, the extension in the two different directions is equally distributed obliquely to, and on each side of, the plane C also extending vertically in the drawing and extending along the rotational axis.

In alternative embodiments, the second cutting element 5 may have an extension in three or more different directions by multiplying the number of cutting edges around the rotational axis of the drilling tool. In still a possible, however not preferred, embodiment, the second cutting element may have an extension in only one direction from the rotational axis of the drilling tool. Such an embodiment, although possible, will however have a limited technical effect with respect to finishing machining, by the drilling tool, of the passage.

The second cutting element constitutes part of a twisted cutting element (see FIG. 1 and FIG. 2) said twisted cutting element extending along a circumferential surface of the drilling tool. The twisted cutting element is a conventional element constituting part of a conventional drilling tool. However, in the embodiment shown, the twisted cutting element has not only one but two lands 8,9 intended for abutting the finished passage subsequent to the second cutting element having machined the passage. The first land 8 and the second land 9 are described with reference to FIG. 1. The addition of a second land 9 improves the alignment of the drilling tool in the passage.

In the embodiment shown in FIG. 4, the first cutting element 4 is extending oppositely on each side of the vertical plane. Furthermore, in the embodiment shown, the first cutting element 4 extends in two diametrically opposite directions. In an alternative embodiment, the first cutting element may be provided on just one side of the plane B. However, such embodiment is not a preferred embodiment. In still alternative embodiments, three or more first cutting elements may extend in angularly different directions being evenly pitched, i.e. having the same angle between the different directions around the rotational axis A of the drilling tool, or being unevenly pitched, i.e. having the not the same angle between at least some of the different directions around the rotational axis A of the drilling tool. Such embodiments are more preferred than the embodiment of the first cutting element provided on only one side of the plane B.

However, the most preferred embodiment is the one showed in FIG. 4, i.e. the first cutting element extending oppositely on each side of a plane B and furthermore extending in two diametrically opposite directions on each side of the plane B.

Also, in the embodiment shown in fig.4, the second cutting elements are also extending oppositely on each side of the horizontal plane. Furthermore, in the embodiment shown, the second cutting element extends at two diametrically opposite locations. In an alternative embodiment, the second cutting element may be provided on just one side of the plane C. However, such embodiment is not a preferred embodiment. In still alternative embodiments, three or more second cutting elements may extend at angularly different directions being evenly pitched, i.e. having the same angle between the different directions around the rotational axis A of the drilling tool, or being unevenly pitched, i.e. having the not the same angle between at least some of the different directions around the rotational axis A of the drilling tool. Such embodiments are more preferred than the embodiment of the first cutting element provided on only one side of the plane C.

However, the most preferred embodiment is the one showed in FIG. 4, i.e. the second cutting element extending oppositely on each side of a plane C and furthermore extending at two diametrically opposite locations on each side of the plane C. However, a possibly more preferred embodiment could be an embodiment, where the second cutting element extends in three opposite directions around the rotational axis A of the drilling tool and with an angular equidistant extension of 120 degrees, i.e. an even pitch, between each of the three opposite directions of the second cutting element, or with other angula extensions, i.e. an uneven pitch between each of the three opposite directions of the second cutting element. Such embodiment will enhance proper alignment of the drilling tool in the passage.

The invention is described with reference to a specific embodiment and with reference to a specific application. However, the invention may be subject to alterations being obvious to the person skilled in the art within the scope of protection of the invention as defined in the claims and as supported by the above description of the invention.

1. A drilling tool with a shaft (1) and a drill head (2), said drilling tool, during drilling, being intended for rotation around a rotational axis (A), and on which drill head (2) a tip (3) is provided with at least two different cutting elements (4,5), and said tip (3) being provided with
at least one first cutting element (4) extending substantially perpendicular to the rotational axis (A), and
at least one second cutting element (5) extending obliquely to the rotational axis, and
said at least one first cutting element (4) having a first radial extension (r) from the rotational axis,
said at least one cutting element (5) having a second radial extension (R) from the rotational axis, and
where the first radial extension (r) is smaller than the second radial extension (R).

2. A drilling tool according to claim 1, where the at least one first cutting element (4) forms an angular extension (α) of between 75 degrees and 90 degrees with the rotational axis (A), preferably between 80 degrees and 90 degrees with the rotational axis (A), even preferred between 85 degrees and 90 degrees with the rotational axis (A).

3. A drilling tool according to claim 1, where the at least one second cutting element (5) forms an angular extension (β) of between 1 degree and 60 degrees with the rotational axis (A).

4. A drilling tool according to claim 1, where the at last one first cutting element (4) constitutes a cutting edge with a geometry similar to a milling edge, said cutting edge extending to the first radial extension (r) from the rotational axis (A).

5. A drilling tool according to claim 4, where the cutting edge has a substantially linear extension, where the cutting edge has an extension in at least two different directions seen from from the rotational axis, and where said extension in the at least two different directions is equally distributed perpendicular to, and on each side of, a plane extending along the rotational axis.

6. A drilling tool according to claim 4, where the cutting edge has a substantially linear extension, where the cutting edge has an extension in at least three different directions around the rotational axis, and where said extension in the at least three different directions is distributed, either by an even pitch or by an uneven pitch, around the rotational axis.

7. A drilling tool according to claim 1, where the at last one second cutting element (5) constitutes a cutting edge being part of a surface having twisted flutes, said cutting edge, being part of the surface having twisted flutes, extending from the first radial extension (r) to the second radial extension (R) from the rotational axis (A).

8. A drilling tool according to claim 7, where the at least one second cutting edge (5) has a shape substantially as a cross-section of a frustum of a cone, where the at least one second cutting edge (5) has an extension in at least two different directions seen from the rotational axis (A), and said extension in the at least two different directions being equally distributed perpendicular to, and on each side of, a plane extending along the rotational axis.

9. A drilling tool according to claim 7, where the at least one second cutting edge (5) has a shape substantially as a cross-section of a frustum of a cone, where the at least one second cutting edge (5) has an extension in three different directions around the rotational axis (A), and said extension in the three different directions being distributed, by an even pitch or by an uneven pitch, around the rotational axis.

10. A drilling tool according to claim 1, where the at last one second cutting element (5) constitutes a cutting edge being part of a surface having straight flutes, said cutting edge, being part of the surface having straight flutes, extending from the first radial extension (r) to the second radial extension (R) from the rotational axis (A).

11. A drilling tool according to claim 10, where the at least one second cutting edge (5) has a shape substantially as a cross-section of a frustum of a cone, where the at least one second cutting edge (5) has an extension in at least two different directions seen from the rotational axis (A), and said extension in the at least two different directions being equally distributed perpendicular to, and on each side of, a plane extending along the rotational axis.

12. A drilling tool according to claim 10, where the at least one second cutting edge (5) has a shape substantially as a cross-section of a frustum of a cone, where the at least one second cutting edge (5) has an extension in three different directions around the rotational axis (A), and said extension in the three different directions being distributed, by an even pitch or by an uneven pitch, around the rotational axis.

13. Method for drilling a hole in a work-piece, and where a passage is provided in the work-piece, said passage having a circular-cylindrical extension with a preliminary diameter, said passage having at least one discontinuity, said discontinuity increasing the preliminary diameter of the passage, and where the preliminary diameter of the passage is intended for being increased by drilling with a drilling tool along the passage, said method comprising the steps of:
displacing the drilling tool along the passage with a first cutting element and a second cutting element,
said first cutting element extending substantially perpendicular to a rotational axis of the drilling tool and having a first radial extension from the rotational axis, and
said second cutting element extending obliquely to the rotational axis of the drilling tool and having a second radial extension from the rotational axis,
selecting the first radial extension of the first cutting element so that the first radial extension has a value between a preliminary radius of the in-finished passage and the second radial extension, respectively, and
selecting the second radial extension of the second cutting element so that the second radial extension has a value as large as an intended fully or partly finished radius of the passage.

14. A method according to claim 13, said method comprising the further steps of:
selecting the first cutting element as a milling element being provided at the tip of the drilling tool and having a cutting edge extending to the first radial extension from the rotational axis.
selecting the second cutting element as a cutting edge being part of a surface having twisted flutes and having the cutting edge extending from the first radial extension to the second radial extension from the rotational axis.

15. Use of a drilling tool according to claim 1 for drilling a passage provided in a work-piece, said passage having a circular-cylindrical extension with a preliminary diameter, and said passage being discontinued by at least one increment of the preliminary diameter of the passage, and where the preliminary diameter of the passage is intended for being increased by drilling.
